(19) United States
(12) Patent Application Publication
(10) Pub. No.: US 2009/0061929 A1
(43) Pub. Date: Mar. 5, 2009

(54) Cell Phone Based Product Research

(75) Inventor: Charles E. Evans, Corvallis, OR (US)

Correspondence Address: Kathy Manke;Avago Technologies Limited, 4380 Ziegler Road, Fort Collins, CO, 80525, US

(73) Assignee: Avago Technologies General IP (Singapore) Pte. Ltd, Fort Collins, CO (US)

(21) Appl. No.: 12/268,390

(22) Filed: Nov. 10, 2008

Related U.S. Application Data
(62) Division of application No. 10/997,111, filed on Nov. 24, 2004.

(51) Int. Cl. H04M 1/00; G06Q 30/00; G06K 7/10

(52) U.S. Cl. 455/556.1; 705/27; 235/462.01

(57) ABSTRACT

A cell phone is used to access product information. The cell phone obtains a universal product code (UPC) for a product. A product identifier for the product along with a request for information about the product is sent from the cell phone to a remote site. The remote site obtains the requested information. The remote site sends the requested information to the cell phone. The cell phone communicates the requested information to the user.

### BACKGROUND

The internet has expanded the availability of marketing information available to a consumer. Available from the internet there are databases and services that allow the user to obtain information on products. The information includes information on pricing, product reviews, similar products and so on. This is all readily accessible to anyone with a computer and an internet connection.

However, many consumers still or additionally want to physically visit a store where they can physically examine and/or try out a product before making a purchase. At the store, however, most consumers do not have a convenient way to obtain product information from the internet. Instead they rely on information provided by product packaging or a salesman, and/or they rely on researched information obtained before of after their visit to a store.

### SUMMARY OF THE INVENTION

In accordance with an embodiment of the present invention, a cell phone is used to access product information. The cell phone obtains a universal product code (UPC) for a product. A product identifier for the product along with a request for information about the product is sent from the cell phone to a remote site. The remote site obtains the requested information. The remote site sends the requested information to the cell phone. The cell phone communicates the requested information to the user.

### BRIEF DESCRIPTION OF THE DRAWINGS

FIG. 1 is a simplified block diagram of a cell phone optimized to perform product research in accordance with an embodiment of the present invention.

FIG. 2 is a simplified flowchart illustrating a session by which product information is accessed from a cell phone in accordance with an embodiment of the present invention.

FIG. 3 is a simplified view of a cell phone display used to make a request for product information during a product research session in accordance with an embodiment of the present invention.

FIG. 4 is a simplified view of a cell phone display used to provide product information during a product research session in accordance with an embodiment of the present invention.

### DESCRIPTION OF THE EMBODIMENT

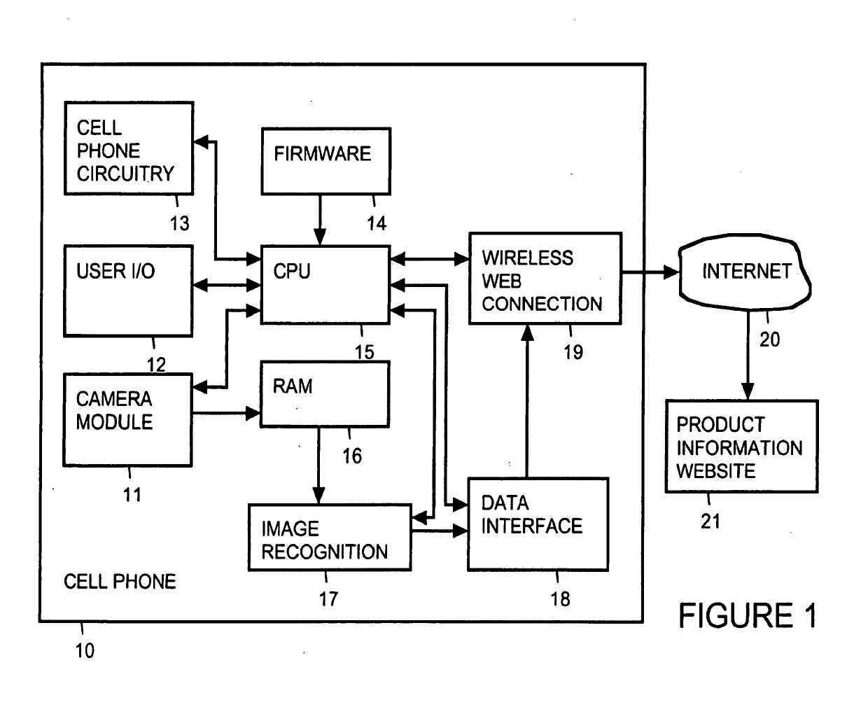

FIG. 1 is a simplified block diagram of a cell phone 10 that is optimized to perform product research. Cell phone 10 includes cell phone circuitry 13 that represents the functionality utilized to perform typical cell phone operations. For example, cell phone circuitry typically includes a microphone, a speaker, wireless cell communication circuitry, automatic number storage, and so on. User input/output (I/O) block 12 represents functionality used to support user input and output functionality. For example, user I/O block 12 includes a phone keypad, a phone display and various other circuitry used to support user input and output. For example, the phone display can include a touchscreen. Alternatively, or in addition, all or part of the phone keypad can be implemented using a touchscreen and keypad display.

A camera module 11 represents the circuitry necessary to capture an image. For example, camera module 11 includes lenses, focusing control, shutter control, and an image sensor device. For example, the image sensor device is made up of a linear array or area array of photon-to-electron converters. The photon-to-electron converters are, for example, charged coupled devices (CCDs), complementary metal oxide semiconductor (CMOS) image sensors or some other type of photon-to-electron converters.

A random access memory (RAM) 16 is used to store image data. Image recognition block 17 is used to recognize the existence of any bar code within an image, to determine the orientation of any recognized bar code, and then to detect the bar code pattern for the purpose of extracting the number represented by the bar code. For example, the number represented by the bar code is converted into a 32-bit word. The 32-bit word is transferred to a data interface block 18.

Data interface block 18 combines the 32-bit word from data interface block 18 with user supplied information to generate a series of commands to be sent through a wireless web connection 19 to a product information website 21 available through internet 20. For example, the user supplied information includes user specified requests for product information. The requests for product information can include, for example, price of the product, identification of merchants selling the product, availability of the product, condition of the product, availability of the product, reviews of the product, features of the product, specifications for the product, information on other products similar to the product, and so on. The user supplied information is obtained from the user through user I/O block 12. When it is impossible or inconvenient for cell phone to scan in a bar code, a user can utilize user I/O block 12 to type in or dictate a universal product code (UPC) for a product about which information is desired.

Central processing unit (CPU) 15 controls and supplements operation of data interface block 18, wireless web connection 19, cell phone circuitry 13, user I/O block 12, camera module 11 and image recognition block 17. Firmware 14 contains programming control information for CPU 15.

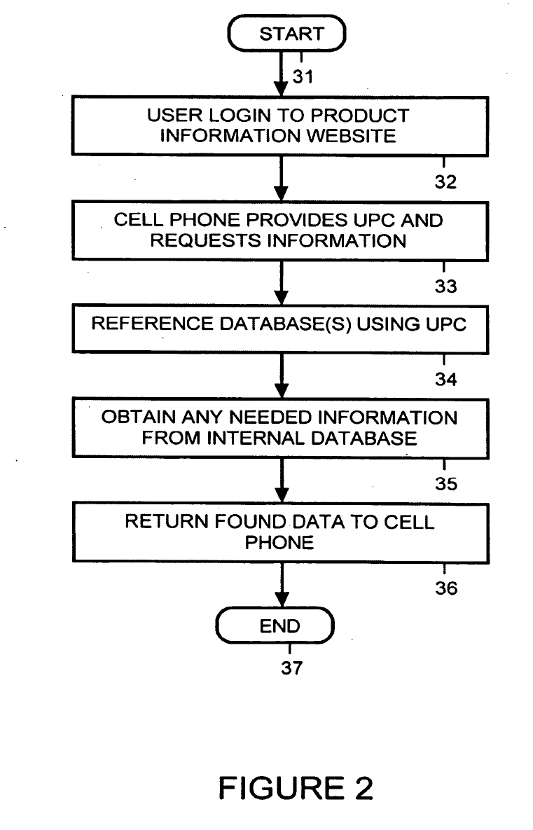

FIG. 2 is a simplified flowchart illustrating a session by which product information is accessed from cell phone 10. Start block 31 is entered after a UPC for a product is obtained, either by a scan or user entry, by cell phone 10. In a block 32, cell phone 10 performs a user login to product information website 21 through internet 20. For example, the login is performed manually by the user utilizing I/O block 12 to request the login and supply any required user name and/or password. Alternatively, for example, the login is performed automatically by cell phone 10 requesting the login and supplying any required user name and/or password in order to log into product information website 21.

In a block 33, cell phone 10 provides product information website 21 with the UPC for the product about which information is desired. Cell phone 10 also provides product information website 21 with one or more commands generated by data interface block 18. The one or more commands include user specified requests for product information. The requests for product information can include, for example one or more of a request for a price comparison, a request for a listing of features, a request for a product review, a request for a list of similar products, and so on.

In a block 34, product information website 21 references one or more databases to obtain the requested product information. For example, the one or more databases may be located internal to product information website 21 and/or may be located external to product information website 21, for example, on other databases accessible by product information website 21 through internet 20.

In a block 35, any requested product information not obtained from the databases accessed in block 34, are accessed from a database located internal to product information website 21.

In a block 36, the requested product information obtained by product information website 21 is returned to cell phone 10. In a block 37, the process is complete. The requested product information is presented to the user of cell phone 10, for example, on a display of cell phone 10 or through an audio presentation made by cell phone 10.

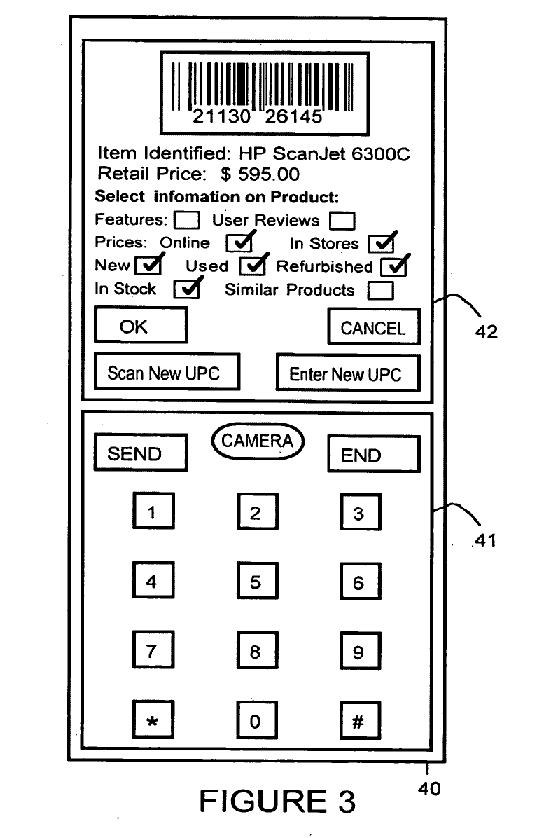

FIG. 3 shows a cell phone 40 having a keypad 41 and a display 42. The current contents of display 42 shown in FIG. 3 result from scanning or entering a UPC code for a product. The UPC code is listed and the product is identified. For example, as shown in FIG. 3, the identified product is an HP ScanJet 6300C. In order to request information about the identified product, the user of cell phone 40 is able to use keypad 41 (or a touchscreen over display 42, if available) to select check boxes shown on display 42. Alternatively, voice recognition functionality can be added to cell phone to allow a microphone to be used to select the check boxes shown on display 42. For example, as shown in display 42, the user has requested information about prices including, prices for new, used or refurbished units available online or in stores that are in stock. The user has not requested information about features of the selected product, user reviews or information about similar products.

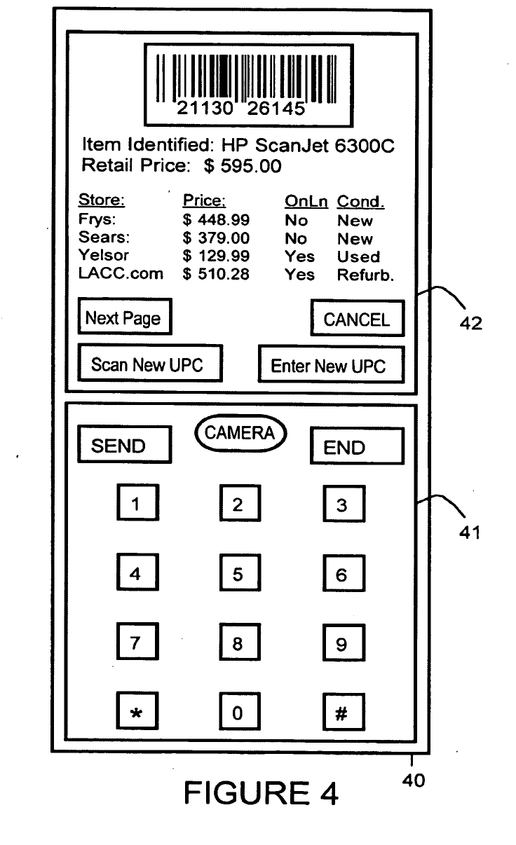

FIG. 4 also shows cell phone 40 having keypad 41 and display 42. The current contents of display 42 shown in FIG. 4 include the results for the information requested by the user. Display 42 lists the requested information about the product for four outlets: Frys, Sears, Yelsor, and LACC.com. Cell phone 40 can also be used to obtain additional product information, such as, for example, consumer reviews, product specifications, and feature comparisons with different products.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

1. A method for a user to obtain product information with a cell phone configured to perform product research, the cell phone comprising a camera module, random access memory (“RAM”) and bar code image recognition circuitry configured to scan a bar code for a product, the image recognition circuitry being configured to extract a universal product code (“UPC”) from the bar code, the method comprising:
scanning the bar code for the product with the cell phone;
extracting, with the image recognition circuitry, the UPC from the scanned bar code;
sending, from the cell phone to a remote site, data representative of the UPC along with a request for information about the product
obtaining, from the remote site, the requested information;
sending the requested information from the remote site to the cell phone; and,
communicating, by the cell phone to the user, the requested information.

2. The method of claim 1, wherein the UPC is entered manually by the user into the cell phone.

3. The method of claim 1, wherein the remote site is a web site available on the internet.

4. The method of claim 1, wherein the product identifier for the product is sent to the remote site over a wireless internet connection.

5. The method if claim 1, wherein the request for information includes a request for at least one of the following:
a price of the product;
an identification of merchants selling the product;
availability of the product;
a condition of the product;
availability of the product;
reviews for the product;
features of the product;
specifications of the product;
information regarding other products similar to the product.

6. The method of claim 1, wherein the cell phone communicates to the user in at least one of the following ways:
through a display; and
through audio presentation.

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. The method of claim 1, wherein the camera module further comprises lenses, focusing control, shutter control, and an image sensor device.

22. The method of claim 1, further comprising storing image data in the RAM corresponding to the scanned bar code.

23. The method of claim 22, wherein extracting the UPC further comprises at least one of recognizing the bar code in the stored image data, determining an orientation of the bar code, and detecting a bar code pattern.

24. The method of claim 1, further comprising logging the user in to the remote web site.

25. The method of claim 1, wherein the remote site references one or more databases to obtain the requested product information.

26. The method of claim 1, further comprising the user using at least one of a keypad, a touchscreen, and voice recognition through a microphone, the keypad, touchscreen or microphone being incorporated into the cell phone, to select at least one check box on a display regarding specific types of information to request about the product.
